SEQUENCE LISTING (1 sequence)

SEQ ID NO: 1 - protein, 4 aa, Artificial Sequence
  globin digest
VVYP

(19) United States
(12) Patent Application Publication
(10) Pub. No.: US 2008/0063781 A1
(43) Pub. Date: Mar. 13, 2008

(54) Globin Digest Containing, Yeast-Fermented Beverages

(75) Inventors: Yoko Kamada, Osaka (JP); Keiichi Abe, Osaka (JP); Shigeo Moriguchi, Kanagawa (JP); Seisuke Takaoka, Tokyo (JP); Yoichi Kakudo, Hyogo (JP)

Correspondence Address: DRINKER BIDDLE & REATH (DC), 1500 K STREET, N.W., SUITE 1100, WASHINGTON, DC, 20005-1209, US

(73) Assignee: Suntory Limited

(21) Appl. No.: 11/664,159

(22) PCT Filed: Mar. 25, 2005
(86) PCT No.: PCT/JP05/05531

§ 371 Date: Sep. 7, 2007

(30) Foreign Application Priority Data
Sep. 30, 2004 (JP) 2004-287936

(51) Int. Cl. A23L 2/66; A23L 2/00; C12C 11/11; A23L 2/52

(52) U.S. Cl. 426/592; 426/590

(57) ABSTRACT

An object of the present invention is to provide globin digest containing, yeast-fermented beverages having a good flavor. To attain this object, a yeast-fermented beverage is used as a base beverage into which the globin digest is to be incorporated. The yeast-fermented beverage may be a beer-taste beverage, preferably, a carbonated beverage.

### TECHNICAL FIELD

This invention relates to beverages containing a globin digest. More particularly, the invention relates to globin digest containing, yeast-fermented beverages that are reduced in the peculiar taste and smell of a globin digest and which are capable of suppressing the elevation of neutral fats.

### BACKGROUND ART

Excessive fat intake is a cause of increased body fat and obesity and, in addition, it has been pointed out that it increases the risk of presenting hyperlipidemia and associated lifestyle-related diseases such as arteriosclerotic disorders, fatty liver and hyperuricemia. High blood neutral fat levels as well as hypercholesterolemia are drawing attention as a risk factor of arteriosclerotic disorders and, among others, triglycerides (hereinafter also referred to as TG) are said to be representative neutral fats. Therefore, in order to prevent and treat vascular disorders including arteriosclerosis, it is desired to lower the blood levels of neutral fats including TG.

As disclosed in JP 9-255698 A, it has recently been found that a composition obtained by digesting globin proteins not only exhibits outstanding action in suppressing the elevation of blood TG levels but also features high safety. According to this document, the active principle is a mixture of oligopeptides having an average amino acid chain length of 3-5 that are typified by VVYP (Val-Val-Tyr-Pro) and VTL (Val-Thr-Leu). The efficacy of this digest composition has also been confirmed in clinical trials (J. Nut., 128, 56-60, 1998; Journal of Japanese Society of Nutrition and Food Science, 52, 71-77, 1999; Journal of Nutritional Food, 5, 131-144, 2002). Mechanisms of action that have been suggested for the globin digest include, for example, (1) suppression of fat absorption by inhibiting pancreatic lipase (Life Sci., 58, 1745-1755, 1996), (2) promotion of chylomicron (CM) TG metabolism (Journal of Japanese Society of Nutrition and Food Science, 52, 71-77, 1999), and (3) promotion of fatty acid metabolism in the liver (Japan. J. Pharmacol., 58 (suppl. I), 80P, 1992).

However, the globin digest has peculiar tastes such as harshness and bitterness, as well as a peculiar aroma, so it has been difficult to use it as a food ingredient. In order to improve its flavor, sweeteners and scents are often used. An improvement in flavor by such means has been attempted in recently commercialized globin digest containing beverages such as napple drink (registered trademark of MG PHARMA INC.), Renefa (registered trademark of Yakult Honsha Co., Ltd.), TAKTY TG (registered trademark of ROHTO Pharmceutical Co., Ltd.), and Teaplus (registered trademark of MORINAGA & CO., LTD.) However, the resulting improvement in flavor is by no means sufficient to withstand intake for a prolonged period. For preventing arteriosclerosis, it is required to suppress the elevation of blood TG levels over an extended period of time. Therefore, it has been necessary to achieve an improvement in flavor to such an extent that it withstands intake for a prolonged period.

It is during or after a meal that there is a great need for the globin digest to exhibit its effectiveness in suppressing the elevation of serum TG levels. Hence, globin digest containing, beverages are preferably such that they can be drunk during a meal and they should not be sweet, nor should they contain an excessive amount of scent. From this viewpoint, the means that have been used in the above-mentioned commercial beverages to improve their flavor are unsatisfactory.

Thus, it has been desired that beverages that have the globin digest added in concentrations that show the action of suppressing the elevation of neutral fats have a satisfactory flavor and can be drunk without problems for an extended period of time.
Patent Document 1: JP 9-255698 A
Non-patent Document 1: J. Nut., 128, 56-60, 1998
Non-patent Document 2: Journal of Japanese Society of Nutrition and Food Science, 52, 71-77, 1999
Non-patent Document 3: Journal of Nutritional Food, 5, 131-144, 2002
Non-patent Document 4: Life Sci., 58, 1745-1755, 1996
Non-patent Document 5: Japan. J. Pharmacol., 58 (suppl. I), 80P, 1992.

### DISCLOSURE OF THE INVENTION

### Problems to be Solved by the Invention

Therefore, an object of the present invention is to provide a method that can be applied to globin digest containing beverages having an outstanding action of suppressing the elevation of neutral fats so as to improve and/or reduce the characteristic taste and smell (aroma) of the globin digest; another object of the present invention is to provide a globin digest containing beverage that is prepared by that method and which is easy to be ingested for an extended period of time.

### MEANS FOR SOLVING THE PROBLEMS

With a view to attaining the above-stated objects, the present inventors conducted intensive studies to find out the types of base beverages that were suitable for masking the aroma and taste (flavor) of the globin digest, as well as the concentrations of the globin digest in those beverages, their pH, and the additives that could be added.

Base Beverage

As a result, the present inventors have found that the flavor of an ingredient derived from yeast fermentation is effective in masking the taste and smell of the globin digest. In particular, it has been found that in carbonated beverages such as regular beer, happoushu (low-malt beer), and beer-taste soft drinks, the masking effect is enhanced in combination with their effervescence that helps expand the flavor of the ingredient derived from yeast fermentation. Thus, the present inventors have confirmed that beverages having such a taste and smell that they can be drunk without problems for an extended period of time can be produced by using a yeast-fermented beverage as a base beverage.

Therefore, the present invention relates to a yeast-fermented beverage that contains a globin digest but which is significantly improved in the flavor that originates from the globin digest.

The “yeast-fermented beverage” as used herein is the generic term for the beverages produced via the fermentation step. Yeast-fermented beverages are usually produced by a process in which yeast is added to a carbohydrate solution prepared from malt and cereals such as barley, rice and corn or carbohydrates and the mixture is subjected to fermentation; the malt as a starting material for the carbohydrate solution may be replaced by plant proteins or their digest. The yeast-fermented beverages are not necessarily those which have passed through the fermentation step, and they include those which have been processed with scents or the like in order to be provided with a flavor similar to the one that originates from fermentation. Therefore, the yeast fermented beverages may include refined sake (Japanese sake), sake-taste alcoholic beverage, shochu (Japanese distilled spirit), mirin (Japanese sweet rice wine for cooking), regular beer, happoushu (low-malt beer), beer-taste soft drinks, fruit wine, whiskeys, spirits, liqueurs, and zasshu (other alcoholic beverages).

The yeast-fermented beverage is preferably a beer-taste beverage. The term “beer-taste beverage” as used herein means beverages having a beer-like flavor such as the aroma from fermentation and the aroma of hop; preferably, it refers to carbonated beverages including regular beer, happoushu (low-malt beer), beer-taste soft drinks, zasshu (other alcoholic beverages), and liqueurs.

The term “regular beer” as used herein refers to beer-taste beverages that have an alcohol content of at least 1 vol %, preferably 3-7 vol %, and which have been produced using at least 67 wt % malt. The term “happoushu (low-malt beer)” refers to beer-like effervescent beverages that have an alcohol content of at least 1 vol %, preferably 3-7 vol %, and which have been produced using less than 67 wt % malt.

The term “beer-taste soft drink” as used herein refers to beer-taste beverages that have an alcohol content of less than 1 vol %. According to the Japanese Liquor Tax Law, beer-taste beverages are classified as alcoholic beverages if they have an alcohol content of at least 1 vol %, and those which have an alcohol content of less than 1 vol % are not alcoholic beverages, and thus, instead are called by the name just given above. Among the beer-taste soft drinks, those having an alcohol content of 0.1 vol % to less than 1 vol % are preferred. Beer-taste soft drinks are also referred to by other names, such as non-alcohol beer or alcohol-free beer.

Beer-taste soft drinks can be produced by various known methods including, for example, (1) dilution, (2) removing alcohol from regular beer (using a reverse osmotic membrane or by distillation), (3) the use of a special yeast or microorganism, (4) stopping the process of fermentation halfway, or (5) preparing a carbohydrate solution without passing through the fermentation step and then blending it with an additive such as a scent. The beer drink of the present invention may be prepared by any of these methods.

In the present invention, a liqueur having a beer taste or zasshu having a beer taste can also be used with advantage, as the base beverage.

The yeast to be used in the production of yeast-fermented beverages in the present invention can be chosen freely considering the product type, the intended flavor, the fermentation conditions, etc. For example, NCYC-229 (purchased from NATIONAL COLLECTION OF YEAST CULTURES), NCYC-401 (purchased from NATIONAL COLLECTION OF YEAST CULTURES), Weihenstephan-184 (purchased from Fachhochschle Weihenstephan), etc. can be used with advantage.

The process of fermentation is stopped to give Moromi (a fermentation mixture), to which a coloring agent, an antioxidant, an acidifier, a scent and the like are added as required according to the usual way. If desired, the alcohol level of the beverage or its flavor can be adjusted by using a reverse osmotic membrane or by diluting it with water or the like. The globin digest may be incorporated into or mixed with the thus prepared yeast-fermented beverage. The yeast-fermented beverage may optionally be passed through a sterilizing step before it is filled into a container such as a bottle or can.

The Concentration of the Globin Digest

As it has been found, the use of the base beverage according to the present invention exhibits a great effect in improving the flavor of the globin digest, even if it is contained at higher concentrations than in the conventional beverages. The concentration of the globin digest in the present invention is preferably 0.1-1.5 g/100 ml, more preferably 0.1-1.0 g/100 ml, and most preferably 0.1-0.7 g/100 ml.

The pH of the Globin Digest Containing Beverages and the pH Modifier

The present inventors have further found that a preferred flavor improving effect can be obtained by adjusting the pH of the beverages to lie within a specified range. The pH of the beverages according to the present invention is preferably in the range of 3.0-4.5, more preferably 3.5-4.5, and most preferably 3.7-4.0.

If the pH of the beverage after fermentation is outside any one of these ranges, a pH modifier may be added as appropriate for pH adjustment. Exemplary pH modifiers include, but are not particularly limited to, lactic acid, phosphoric acid, and citric acid.

Definition of the Globin Digest

The “globin digest” as used in the present invention is a peptide mixture based on oligopeptides having an average amino acid chain length of 3-5, that is obtained by hydrolyzing the globin protein that composes hemoglobin or myoglobin. Hemoglobin and myoglobin preferably originate from bovines, swine, sheep, humans, horses, etc. and, in particular, those which originate from bovine or swine blood are preferred. Hydrolysis is preferably performed using at least one protease selected from the group consisting of acidic proteases, neutral proteases, and alkaline proteases. In particular, it is preferred to use an acidic protease, particularly one that originates from Aspergillus niger. Hydrolysis may be performed as described in WO 89/09670; first, a globin protein containing solid is dispersed in water in an amount of 5-30 wt %, then the liquid dispersion is adjusted with an acid or alkali to an optimum pH for a protease, which is added, either at a time or successively, in an amount of 0.1-5 units for 0.1 mg of the protein contained in the liquid dispersion, and subjected to a reaction at 20-70° C. for 3-48 hours, preferably for 16-30 hours. (Note that one unit of protease is an enzymatic titer which, given whey casein as a substrate, produces a non-proteinous substance, which develops a color with Folin's reagent, in an amount equivalent to 1 μg of tyrosine, at an optimum pH for the enzyme at 30° C. for 1 minute.) The oligopeptides in the globin digest have a molecular weight distribution of 100-1500. Molecular weight distribution can be measured by any one of the commonly employed methods and a preferred method of measurement is, for example, gel filtration.

The average amino acid chain length of the oligopeptides contained in the hydrolysate can be measured by a known method such as the combination of chromatography with mass spectrometry.

JP 9-255698 A reports the isolation of a peptide having sequence number 1: VVYP (Val-Val-Tyr-Pro) and the peptide VTL (Val-Thr-Leu) as the primary active ingredients in the globin digest, and it observes that these peptides have a strong suppressive activity against the elevation of serum triglyceride levels. Preferably, the globin digest of the present invention contains at least 0.1 wt % of VVYP or VTL.

Furthermore, in the present invention, the globin digest in its broad sense covers the oligopeptides VVYP and/or VTL as separated from the above-described globin digest following, for example, the descriptions in JP 9-255698 A.

The globin digest can optionally be purified by an ion-exchange resin, ultrafiltration, reverse-phase column chromatography, etc. It has been shown that if, after treatment with an ion-exchange resin, free amino acids are removed by ultrafiltration, the activity of suppressing the elevation of serum TG is enhanced (JP 9-255698 A).

The globin digest suitable for use in the present invention is commercially available and may be purchased from, for example, MG PHARMA INC. The globin digest available from that company is a mixture of oligopeptides having 3-5 amino acid residues on average, with it containing about 0.6 wt % of VVYP and having a molecular weight distribution of 100-1500.

Method of Reducing the Taste and Smell Peculiar to the Globin Digest

The present invention also relates to a method of reducing the taste and smell that are peculiar to the globin digest in globin digest containing beverages. The method covers the use of a yeast-fermented beverage as the base beverage in which the globin digest is to be contained. The globin digest containing beverage in this method also preferably has at least one of the characteristics described above with respect to the base beverage, the digest, the concentration of the digest, pH, and the pH modifier.

Effectiveness in Suppressing the Elevation of Neutral Fats

The present invention also relates to a globin digest containing, yeast-fermented beverage that has a label indicating to the effect that it is effective in suppressing the elevation of serum triglyceride levels or in suppressing the elevation of neutral fats. The indication may be put on the container itself or in the manual attached to it. Examples of the container for the beverage include, but are not limited to, casks, bottles, cans, PET bottles, etc. Examples of the labeling method include, but are not limited to, printing, stamping, sealing, etc.

The effectiveness in suppressing the elevation of neutral fats means the effectiveness in lowering the neutral fat levels in the blood of animals. A preferred neutral fat is triglycerides (TG). By suppressing the elevation of neutral fats, hyperlipidemia can be prevented and/or treated, with a potential for the effectiveness in preventing and/or treating arteriosclerosis.

The effectiveness in suppressing serum TG fat can be evaluated as described in Example 5 to be given later, and the evaluation may follow the method described in JP 9-255698 A. In one example of evaluation, an animal of interest is administered a sample under test together with a feed and after the lapse of a specified time, blood is collected from the animal and measured for the TG level. TG levels may be measured using, for example, an automatic analyzer (HITACHI 7070 of Hitachi, Ltd.) or Triglyceride G Test Wako (Wako Pure Chemical Industries, Ltd.)

The amount of the globin digest that is required for it to show its activity in suppressing the elevation of neutral fats is about 1 mg daily as the globin digest per adult. Therefore, the beverage of the present invention is desirably such that a single dosage of its intake contains at least 1 mg of the globin digest. However, if the beverage of the present invention is to be ingested in more than one container, it may contain less than 1 mg of the globin digest.

### ADVANTAGES OF THE INVENTION

The present invention provides a globin digest containing, yeast-fermented beverage that has a good flavor and which has an action of suppressing the elevation of neutral fats. Because of its good flavor, the beverage of the present invention is suitable for ingestion over an extended period of time.

In one embodiment of the present invention, the beverage is a beer-taste one. Beer-taste beverages including regular beer, happoushu (low-malt beer), and beer-taste soft drinks have taste that people will stick to them once they find them preferable. Therefore, if the globin digest is added to these beverages without impairing their flavor, it is expected that they can be ingested more easily over a continued period than the conventional globin digest containing beverages. In addition, yeast-fermented beverages such as beer-taste beverages are often ingested together with meals having high fat content. Therefore, if these beverages are provided with the action of suppressing the elevation of neutral fats, it is also expected that they can be ingested on an appropriate timing to prevent and/or treat hyperlipidemia.

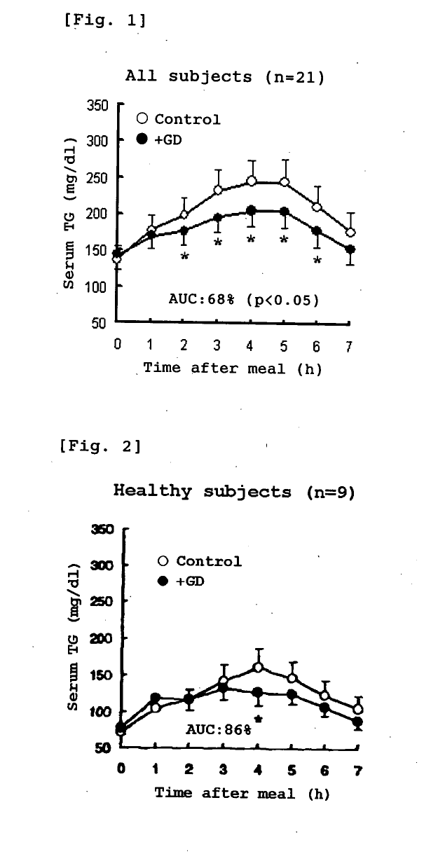

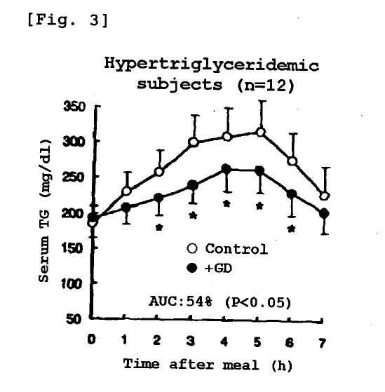

### BRIEF DESCRIPTION OF THE DRAWINGS

[FIG. 1] FIG. 1 is a graph showing the time course of serum triglyceride level in all subjects who ingested the globin digest (GD) containing beverage of the present invention or a control beverage, together with a fatty meal; ● shows the result of ingesting the GD containing beverage, and ∘ shows the result of ingesting the control beverage.

[FIG. 2] FIG. 2 is a graph showing the time course of serum triglyceride level in healthy subjects who ingested the globin digest (GD) containing beverage of the present invention or a control beverage, together with a fatty meal; ● shows the result of ingesting the GD containing beverage, and ∘ shows the result of ingesting the control beverage.

[FIG. 3] FIG. 3 is a graph showing the time course of serum triglyceride level in a group of hypertriglyceridemic subjects who ingested the globin digest (GD) containing beverage of the present invention or a control beverage, together with a fatty meal; ● shows the result of ingesting the GD containing beverage, and ∘ shows the result of ingesting the control beverage.

### EXAMPLES

On the following pages, the present invention is described more specifically with reference to examples, to which the present invention is by no means limited.

In each of the experiments shown below, the unit (%) as employed in association with the content of the globin digest shall have the same meaning as g/100 ml.

### EXAMPLE 1

### The Effect of Various Base Beverages in Reducing the Flavor from the Globin Digest

The effect of masking the flavor from the globin digest was evaluated using various base beverages. Considering the consumption during a meal, the base beverages to be tested were chosen from those having no sweet taste.

The various commercial beverages listed in Table 1 below were used as the base beverages to prepare a variety of beverages each containing 0.3% of the globin digest. The process of preparation consisted of adding a commercial globin digest (MG PHARMA INC.) in powder form to the various commercial beverages, and mixing them together to form solutions. For barley shochu, whiskey and brandy, a commercial grade having an alcohol content of 40-44 vol % was diluted with water to prepare a base beverage having an alcohol content of 5 vol %.

The beverages thus prepared were subjected to an organoleptic test for evaluating their effectiveness in masking or reducing the flavor from the globin digest.

Evaluation was made in terms of three factors, aroma (the presence or absence of the smell peculiar to the globin digest), taste (the presence or absence of harshness), and the difference from the flavor of a beverage not containing the globin digest. The test was performed by 6 trained panelists.

The flavor was evaluated by scores from 1 (very hard to drink) to 5 (very easy to drink). The difference from the flavor of a beverage not containing the globin digest was evaluated by scores from 1 (very much different) to 5 (no difference observed). In each evaluation, score 3 was taken as a standard level (acceptable), and rating was given in increments of 0.5. The scores given by the individual panelists were averaged for each base beverage, and the results are shown in Table 1. Average scores of 3 or more are labeled ∘, average scores of from 2 to less than 3 are labeled Δ, and average scores of less than 2 are labeled X.

TABLE 1

| | Base beverage | | | | | | | | | | | | |
|---|---|---|---|---|---|---|---|---|---|---|---|---|---|
| | | | | beer- | | | | | | | | | |
| | | | | taste | | | | | | | | | |
| | | regular | | soft | barley | | | red | white | green | black | barley | oolong |
| | water | beer | Happoushu | drink | shochu | whiskey | brandy | wine | wine | tea | tea | tea | tea |
| Alcohol level | — | 5.0 | 5.4 | 0.5 | 5.0 | 5.0 | 5.0 | 12 | 12 | — | — | — | — |
| (%) | | | | | | | | | | | | | |
| Globin digest | 0.3 | 0.3 | 0.3 | 0.3 | 0.3 | 0.3 | 0.3 | 0.3 | 0.3 | 0.3 | 0.3 | 0.3 | 0.3 |
| concentration | | | | | | | | | | | | | |
| (%) | | | | | | | | | | | | | |
| Taste | X | ◯ | ◯ | ◯ | X | ◯ | ◯ | Δ | Δ | ◯ | ◯ | Δ | ◯ |
| Aroma | X | ◯ | ◯ | ◯ | Δ | ◯ | ◯ | ◯ | Δ | Δ | ◯ | Δ | ◯ |
| Comparison | X | ◯ | ◯ | ◯ | Δ | ◯ | ◯ | Δ | X | X | X | X | X |
| with a | | | | | | | | | | | | | |
| beverage | | | | | | | | | | | | | |
| containing no | | | | | | | | | | | | | |
| globin digest | | | | | | | | | | | | | |

As is clear from Table 1, the aroma- and taste-masking effects were high in the regular beer, happoushu, beer-taste soft drink, whiskey and brandy, with, no difference in flavor being observed in comparison with the corresponding beverages containing no globin digest. Among others, the beer-taste beverages such as regular beer, happoushu and beer-taste soft drink were evaluated very highly for the aroma- and taste-masking effects, and proved to be easy-to-drink beverages.

Also, the red wine and barley shochu showed no marked difference in flavor from the corresponding beverages containing no globin digest and, hence, their flavor was somewhat improved.

These results were probably due to the high ability of the flavor from yeast fermentation to mask the flavor from the globin digest. The very high rating given to the carbonated beverages such as regular beer was probably due to their effervescence which caused the flavor from yeast fermentation to expand in the mouth, further enhancing its masking effect.

From the foregoing results, it was found that regular beer, happoushu and beer-taste soft drinks, which are popular as beverages to be drunk during a meal, are suitable for consumption as beverages that would mask or reduce the flavor from the globin digest. Similarly, beverages, preferably beer-taste ones, which are effervescent and have the flavor from yeast fermentation are also considered to be suitable for use in reducing the flavor from the globin digest.

### EXAMPLE 2

### The Effect of the Amount of the Globin Digest to be Added

The regular beer and beer-taste soft drink that were found to have the flavor-masking or flavor-reducing effect in Example 1 were used as base beverages, and the amount of addition of the globin digest was varied to study its effect on the masking or reduction of the flavor.

Beverages were prepared that contained various amounts of the globin digest. Water was used as a control.

Having a high amino acid content, the globin digest shows a pH buffering ability when added to beverages. Hence, the pH of the as-prepared beverage will vary depending on the amount of addition of the globin digest. In order to cancel any influences which may be caused by the variability of pH, the test in Example 2 was carried out with citric acid being added such that the pH of all test beverages was adjusted to 4.0 before evaluation was made. The organoleptic test was conducted by 6 trained panelists. The factors to be evaluated and the method of evaluation were the same as in Example 1.

The results are shown in Tables 2 to 4.

[Table 2]

TABLE 2
(control; water)

| | Globin digest concentration (%) | | | | | | |
|---|---|---|---|---|---|---|---|
| | 0.01 | 0.1 | 0.3 | 0.5 | 0.7 | 1 | 1.5 |
| Taste | ◯ | Δ | X | X | X | — | — |
| Aroma | ◯ | Δ | X | X | X | — | — |
| Comparison with a | ◯ | Δ | X | X | X | — | — |
| beverage containing | | | | | | | |
| no globin digest | | | | | | | |

[Table 3]

TABLE 3
(regular beer)

| | Globin digest concentration (%) | | | | | | |
|---|---|---|---|---|---|---|---|
| | 0.01 | 0.1 | 0.3 | 0.5 | 0.7 | 1 | 1.5 |
| Taste | — | ◯ | ◯ | ◯ | ◯ | ◯ | X |
| Aroma | — | ◯ | ◯ | ◯ | ◯ | ◯ | Δ |
| Comparison with a | — | ◯ | ◯ | ◯ | ◯ | ◯ | X |
| beverage containing no | | | | | | | |
| globin digest | | | | | | | |

[Table 4]

TABLE 4
(beer-taste soft drink)

| | Globin digest concentration (%) | | | | | | |
|---|---|---|---|---|---|---|---|
| | 0.01 | 0.1 | 0.3 | 0.5 | 0.7 | 1 | 1.5 |
| Taste | — | ◯ | ◯ | ◯ | ◯ | ◯ | X |
| Aroma | — | ◯ | ◯ | ◯ | ◯ | ◯ | Δ |
| Comparison with a beverage | — | ◯ | ◯ | ◯ | ◯ | ◯ | X |
| containing no globin digest | | | | | | | |

In the test with water, when the globin digest was added in amounts of 0.1% and more, its characteristic aroma and taste were recognized, making the beverage more difficult to drink. Further, at those concentrations of the globin digest, there was observed a difference from the flavor of the beverage without the globin digest. On the other hand, in the regular beer and the beer-taste soft drink, when the globin digest was added in amounts ranging from 0.1 to 1.5%, there was observed a decrease in the aroma peculiar to the globin digest; in particular, within the range from 0.1 to 1.0%, there was observed a decrease in both the aroma and taste but with no difference in aroma and taste as compared with the beverages without the globin digest; it should be particularly noted that within the range from 0.1 to 0.7%, high rating was given in both aroma and taste, without any difference from the beverages containing no globin digest.

From the foregoing, it became clear that the technology of the present invention proved effective when the concentration of the globin digest was at least 0.1%, or the level at which the effect of the flavor of the globin digest began to appear markedly in the control. It also became clear that the upper limit of the concentration of the globin digest at which it exhibited the aroma reducing effect was 1.5%, and that the upper limit of its concentration at which it exhibited the aroma- and taste-reducing effect was 1.0%.

### EXAMPLE 3

### The Effect of pH

Regular beer and beer-taste soft drink were studied for the effect of pH on the their effectiveness in masking or reducing the flavor from the globin digest.

Commercial regular beer and beer-taste soft drink were used. The concentration of the globin digest was adjusted to 0.3% in all samples. For pH adjustment, citric acid or phosphoric acid was added as a pH modifier. When no pH modifier was added, both the regular beer and the beer-taste soft drink had a pH of 4.5.

The thus prepared beverages having various pHs were evaluated for their aroma, taste, and as to how ease they could be drunk. The methods of evaluating aroma and taste were the same as in Example 1. The ease of drinking was evaluated in five scores ranging from one (very hard to drink) to five (very easy to drink). Score 3 was taken as a standard level (acceptable), and rating was given in increments of 0.5. Average scores of 3 or more are labeled ∘, average scores of from 2 to less than 3 are labeled Δ, and average scores of less than 2 are labeled X.

The results are shown in Tables 5 and 6.

[Table 5]

TABLE 5

| | Base beverage | | | | | | | | | |
|---|---|---|---|---|---|---|---|---|---|---|
| | beer | | | | | | | | | |
| | pH modifier | | | | | | | | | |
| | citric acid | | | | | phosphoric acid | | | | |
| | pH | | | | | | | | | |
| | 3.0 | 3.5 | 3.7 | 4.0 | 4.5 | 3.0 | 3.5 | 3.7 | 4.0 | 4.5 |
| Aroma | ◯ | ◯ | ◯ | ◯ | ◯ | ◯ | ◯ | ◯ | ◯ | ◯ |
| Taste (the presence or | ◯ | ◯ | ◯ | ◯ | Δ | ◯ | ◯ | ◯ | ◯ | Δ |
| absence of harshness) | | | | | | | | | | |
| Taste as a beverage | X | Δ | ◯ | ◯ | ◯ | X | Δ | ◯ | ◯ | ◯ |

[Table 6]

TABLE 6

| | Base beverage | | | | | | | | | |
|---|---|---|---|---|---|---|---|---|---|---|
| | beer-taste soft drink | | | | | | | | | |
| | pH modifier | | | | | | | | | |
| | citric acid | | | | | phosphoric acid | | | | |
| | pH | | | | | | | | | |
| | 3.0 | 3.5 | 3.7 | 4.0 | 4.5 | 3.0 | 3.5 | 3.7 | 4.0 | 4.5 |
| Aroma | ◯ | ◯ | ◯ | ◯ | ◯ | ◯ | ◯ | ◯ | ◯ | ◯ |
| Taste (the presence or | ◯ | ◯ | ◯ | ◯ | Δ | ◯ | ◯ | ◯ | ◯ | Δ |
| absence of harshness) | | | | | | | | | | |
| Taste as a beverage | X | Δ | ◯ | ◯ | ◯ | X | Δ | ◯ | ◯ | ◯ |

In both the regular beer and the beer-taste soft drink, the aroma of the globin digest was masked independently of the pH they had. The taste-masking effect was observed at pHs of 3.0-4.5, and it was particularly marked at pHs of 3.0-4.0. However, there was less ease of drinking at low pHs, with a preferred pH range being 3.5-4.5, with the range of 3.7-4.5 being more preferred. There was observed no difference with the type of the pH modifier used.

With all of the foregoing data being taken together, a conclusion is reached that when the concentration of the globin digest is around 0.3%, the pH of beverages is preferably 3.0-4.5, more preferably 3.5-4.5, and most preferably 3.7-4.0, irrespective of the type of pH modifier used.

### EXAMPLE 4

### Exemplary Preparation of a Globin Digest Containing, Beer-Taste Beverage

With a beer-taste soft drink chosen as a base beverage, the beverage of the present invention was prepared on a pilot scale.

Malt and an auxiliary material (saccharified starch) were mixed at a weight ratio of 60:40 to prepare a carbohydrate solution; using Weihenstephan-184 as a yeast, fermentation was performed but stopped the fermentation halfway to prepare a beer-taste soft drink with 0.5 vol % alcohol. To this base beverage, the globin digest was subsequently added such that its concentration was 0.3% (i.e., 0.3 g/100 ml) and the mixture was stirred. The thus prepared beverage had a pH of 4.5, and lactic acid was added to afford a pH of 4.0; the beverage was then filled into bottles.

The thus prepared product was evaluated for its taste and aroma; it had no flavor derived from the globin digest, and it was hence found to be suitable for ingestion over an extended period of time.

### EXAMPLE 5

### Effectiveness of Globin Digest Containing, Beer-Taste Beverage in Suppressing the Elevation of Neutral Fat and Other Levels

(1) Volunteers in Test

According to the Guidelines for Diagnosis and Treatment of Hyperlipidemia (The Committee on the Guidelines for Diagnosis and Treatment of Hyperlipidemia, Japan Atherosclerosis Society: Guidelines I for Diagnosis and Treatment of Hyperlipidemia, Guidelines for Diagnosis of Adult Hyperlipidemia, Applicable Guidelines in Treatment, Target Values in Treatment; Domyaku Koka, 25, 1-34, 1997), a condition with serum TG levels of 150 mg/dl and more is called hypertriglyceridemia. In “Shishitsu-no Kagaku (Chemistry of Lipids)” by Tadao Yasugi (Asakura Shoten, pp. 126-133, 1990), a condition with serum TG levels of 111-149 mg/dl is called borderline hypertriglyceridemia, from the viewpoint of the risk of arteriosclerosis. Therefore, in the test under consideration, persons with fasting serum TG levels of 110 mg/dl and less were classified as healthy subjects, and persons with 111 mg/dl and more were classified as hypertriglyceridemic subjects.

Adult males and females who showed comparatively high serum TG levels (TG in 111 mg/dl and more) in a periodical physical checkup (within 3 months of the test) were recruited, and 21 subjects who were not receiving any treatment with drugs such as a therapeutic for hyperlipidemia were chosen as volunteers. These volunteers consisted of 12 hypertriglyceridemic subjects and 9 healthy subjects.

(2) Test Diet

The food to be subjected to the test consisted of a globin digest (GD) containing beverage and a fatty meal.

The GD containing beverage used a beer-taste beverage as a base beverage, contained 1 g of GD per bottle (350 ml) (ca. 0.29 g/100 ml), and had a pH of 3.8. This beverage had a calorific value of about 55 kcal per bottle. The control beverage was identical to the GD containing beverage except that it did not contain GD, and it could not be distinguished from the GD containing beverage with respect to the appearance and shape.

GD (MG PHARMA INC.) was a mixture of oligopeptides having 3-5 amino acid residues on average; it had a molecular weight distribution of 100-1500, and consisted of 92 wt % protein (10 wt % free amino acids), 2.3 wt % carbohydrate, 2.9% ash, and 2.8 wt % water.

The fatty meal consisted of 200 g of commercial corn cream potage soup (Corn Cream Potage of Meiraku Co., Ltd.), to which were added 19 g of butter (unsalted butter of Snow Brand Milk Products Co., Ltd.), and 15 g of lard (lard of Snow Brand Milk Products Co., Ltd.)

The test diet consisting of a bottle of the GD containing beverage and the fatty meal had a total energy of 496 kcal, with its nutrient composition consisting of 40.4 g lipid, 14.8 g carbohydrate, 4.8 g protein, and 2.1 g ash. The control diet consisting of a bottle of the control beverage and the fatty meal was identical to the test diet except for the slight differences in the protein content (3.8 g) and the total energy (492 kcal).

(3) Test Method

The test was a crossover trial. The subjects were each given a bottle of the GD beverage and the fatty meal (containing 40 g fat) at the same time and, after a week of recovery, they were each given a bottle of the control beverage and the fatty meal; alternatively, the order of ingestion was reversed. The subjects were allocated randomly and placed in a blind test without being informed of what they were to drink.

The subjects were fasted since 9 p.m. on the previous night until 9 a.m. in the next morning when the test was started. Throughout the test, the subjects were fasted with limited access to a small amount of water. The subjects were also limited in exercise and either kept at rest in a sitting position or permitted to work on light duty. Before ingesting the test diet or control diet, as well as 1, 2, 3, 4, 5, 6 and 7 hours after ingestion, blood samples were collected from the subjects (in ca. 5 mL) through the radius vein.

The blood was collected in a tube into which a separator had been added; after being left to stand at 5° C. for about 30 minutes, the blood was centrifuged at 1,000 g for 15 minutes to give serum.

Serum TG was measured enzymatically with an automatic analyzer (HITACHI 7070 of Hitachi, Ltd.) At the same time, chylomicron and VLDL (very low-density lipoprotein) were analyzed as lipoprotein fractions. Chylomicron is dietary fat that manifested itself in the blood after it was absorbed through the small intestine. VLDL which stands for a very low-density lipoprotein is known to be easily metabolized into a low-density lipoprotein (LDL) which is known as a lipoprotein that can be a cause of arteriosclerosis. To measure these lipoprotein fractions, a serum lipoprotein faction assay kit “BLF EIKEN II” (registered trademark of Eiken Chemical Co., Ltd.) which relied upon dextran sulfate nephelometry was employed, with the BL standard serum attached to the kit being used as the standard. Also analyzed was RLP-cholesterol (remnant-like particulate cholesterol). RLP-cholesterol is recognized to reflect the concentration of chylomicron remnant. Chylomicron remnant is an intermediate metabolite that is produced from chylomicron when it is partly hydrolyzed with lipase; chylomicron remnant is known to be an arteriosclerosis-inducing lipoprotein. RLP-cholesterol was isolated using JIMRO-II (Japan Immunology Research Institute).

All of these measurements were conducted at Shionogi Biomedical Laboratories (Settsu City) and completed within 3 days after blood collection.

The areas under curves (AUC) for blood level were calculated from the 0-7 hour blood levels in accordance with the trapezoidal method described in Am. J. Clin. Nutr., 54, 846-854, 1991.

(4) Statistical Analysis

The measured values were expressed as means±standard error. The effectiveness of the GD beverage in suppressing the elevation of serum lipid levels after ingestion of the test diet was evaluated by means of the measured values at the respective hours and the calculated AUCs. The results were analyzed by one-way ANOVA (randomized blocks method) as contrasted with the control group. Significant differences were determined with a risk of less than 5% being set as a significance level.

(5) Experimental Results

Both the group of healthy subjects and the group of hypertriglyceridemic subjects were allowed to ingest the GD containing beverage or the control beverage together with the fatty meal, and the serum TG was measured over time. The results are shown in FIGS. 1 to 3. The serum TG levels (sTG) are expressed in mg/dl. The closed dots (●) refer to the results of drinking the GD containing beverage, and the open circles (∘) refer to the results of drinking the control beverage.

The subjects were found to experience significant elevations of TG upon ingesting the control diet consisting of the fatty meal and the control beverage (FIG. 1). The elevations of TG in the group of hypertriglyceridemic subjects (FIG. 3) were more significant than those in the group of healthy subjects (FIG. 2).

On the other hand, when the subjects ingested the GD beverage together with the fatty meal, a significant effect of suppressing the elevation of serum TG was observed (FIG. 1). This effect was particularly marked in the group of hypertriglyceridemic subjects (FIG. 3) than in the group of healthy subjects (FIG. 2). The effect of suppressing the elevation of serum TG was also clear from the AUC values (0-7 hours) of TG levels. In the whole group, the AUC was suppressed to 68% of the data for the case of ingesting the control diet. The suppression was to 86% in the group of healthy subjects, and 54% in the group of hypertriglyceridemic subjects.

Thus, there was observed a significant effect of suppressing the elevation of serum TG when the GD containing beverage was drunk at the time of ingesting the fatty meal. This effect was observed in both groups of healthy subjects and hypertriglyceridemic subjects but it was particularly high in the group of hypertriglyceridemic subjects.

Ingestion of the GD beverage was also found to be effective in suppressing the elevation of serum chylomicron, RLP-cholesterol and VLDL. This effect was marked in hypertriglyceridemic subjects and the AUCs were suppressed to 62%, 60% and 60%, respectively, of the data for the control group. It has been noted that increased levels of those substances are linked to arteriosclerosis.

Hence, it has become clear that the beverages of the present invention, which are effective in suppressing the elevation of TG, also have a desirable effect in the prevention or treatment of hyperlipidemia.

1: A yeast-fermented beverage containing a globin digest.

2: The yeast-fermented beverage according to claim 1, wherein the globin digest contains the peptide of sequence number 1 and/or the peptide Val-Thr-Leu.

3: The yeast-fermented beverage according to claim 1, which is a beer-taste beverage.

4: The yeast-fermented beverage according to claim 1, which is a carbonated beverage.

5: The yeast-fermented beverage according to claim 4, wherein the carbonated beverage is regular beer, happoushu (low-malt beer), a beer-taste soft drink, a liqueur, or zasshu (other alcoholic beverages).

6: The yeast-fermented beverage according to claim 1, wherein the concentration of the globin digest is 0.1 to 1.5 g/100 ml, preferably 0.1 to 1.0 g/100 ml, and more preferably 0.1 to 0.7 g/100 ml.

7: The yeast-fermented beverage according to claim 1, which has a pH of 3.0 to 4.5, preferably 3.5 to 4.5, and more preferably 3.7 to 4.0.

8: The yeast-fermented beverage according to claim 7, which has a pH modifier added thereto.

9: The yeast-fermented beverage according to claim 8, wherein the pH modifier is citric acid, phosphoric acid, or lactic acid.

10: The yeast-fermented beverage according to claim 1, which has a label indicating to the effect that it is effective in suppressing the elevation of serum triglyceride levels or the elevation of neutral fats.

11: A process for producing the yeast-fermented beverage according to claim 1, which comprises incorporating a globin digest in the yeast-fermented beverage.

12: A method of improving the taste and smell that are peculiar to a globin digest in a globin digest containing beverage, by using a yeast-fermented beverage as a base beverage into which the globin digest is to be incorporated.

13: The method according to claim 12, wherein the globin digest contains the peptide of sequence number 1 and/or the peptide Val-Thr-Leu.

14: The method according to claim 12, wherein the yeast-fermented beverage is a beer-taste beverage.

15: The method according to claim 12, wherein the yeast-fermented beverage is a carbonated beverage.

16: The method according to claim 15, wherein the carbonated beverage is regular beer, happoushu (low-malt beer), a beer-taste soft drink, a liqueur, or zasshu.

17: The method according to claim 12, wherein the concentration of the globin digest is 0.1 to 1.5 g/100 ml, preferably 0.1 to 1.0 g/100 ml, and more preferably 0.1 to 0.7 g/100 ml.

18: The method according to claim 12, wherein the beverage has a pH of 3.0 to 4.5, preferably 3.5 to 4.5, and more preferably 3.7 to 4.0.

19: The method according to claim 18, wherein pH adjustment is effected with a pH modifier.

20: The method according to claim 19, wherein the pH modifier is citric acid, phosphoric acid, or lactic acid.
